(19) United States
(12) Patent Application Publication
(10) Pub. No.: US 2009/0091740 A1
(43) Pub. Date: Apr. 9, 2009

(54) METHODS AND SYSTEMS FOR ANALYZING SOLIDS

(75) Inventors: Nathan Kane, East Haven, CT (US); Michael MacPhee, Pawtucket, RI (US); Mark Oliveira, Framingham, MA (US)

Correspondence Address: PHILIP S. JOHNSON;JOHNSON & JOHNSON, ONE JOHNSON & JOHNSON PLAZA, NEW BRUNSWICK, NJ, 08933-7003, US

(73) Assignee: TransForm Pharmaceuticals, Inc., Lexington, MA (US)

(21) Appl. No.: 10/599,804

(22) PCT Filed: Apr. 14, 2005
(86) PCT No.: PCT/US05/12686

§ 371 Date: Oct. 20, 2008

Related U.S. Application Data
(60) Provisional application No. 60/562,358, filed on Apr. 15, 2004.

(51) Int. Cl. G01N 23/201; G01N 1/00; G01J 3/00

(52) U.S. Cl. 356/36; 378/88; 356/51

(57) ABSTRACT

Methods and systems for the analysis of solid materials are disclosed. The present invention comprises x-ray and Raman analytical techniques and systems which facilitate the rapid characterization of a plurality of solid samples.

### CROSS-REFERENCE TO RELATED APPLICATIONS

The present application claims the benefit of priority of U.S. Provisional Application Ser. No. 60/562,358, filed Apr. 15, 2004, which is hereby incorporated by reference herein in its entirety, including any figures, tables or drawings.

### TECHNICAL FIELD OF THE INVENTION

This invention relates to methods and apparatuses for transferring and manipulating solids for the purpose of automating PXRD (powder X-ray diffraction), Raman spectroscopy, or other compatible methods of analysis. Specific embodiments of the invention are particularly suited for the automated transfer and analysis of small quantities of solid particles.

### BACKGROUND OF THE INVENTION

Structure plays an important role in determining the properties of substances. The properties of many compounds can be modified by structural changes, for example, different polymorphs of the same pharmaceutical compound can have different therapeutic activities. Understanding structure-property relationships is crucial in efforts to maximize the desirable properties of substances, such as, but not limited to, the therapeutic effectiveness of a pharmaceutical.

This invention relates generally to systems and methods for rapidly determining the characteristics of an array of diverse materials, and to systems and methods for rapidly determining the characteristics of a library of diverse materials using electromagnetic radiation.

### SUMMARY OF THE INVENTION

In a first embodiment, the present invention provides a method for the analysis of a solid material, comprising:
(a) coring the solid material with a coring tool such that a plug is formed;
(b) extruding the plug of solid material;
(c) exposing the plug of solid material to radiation; and detecting scattered radiation.

In another embodiment, the present invention provides a method for the analysis of a plurality of solid samples, comprising:
(a) coring each solid sample with a coring tool such that each solid sample forms a plug;
(b) extruding each plug of solid material;
(c) exposing each plug of solid material to radiation; and
(d) detecting scattered radiation.

In another embodiment, the present invention provides a system for analyzing a solid material, comprising:
(a) a coring tool comprising a means for extruding a plug of solid material;
(b) a means for exposing the plug of solid material to radiation; and
(c) a means for detecting scattered radiation.

In another embodiment, the present invention provides a system for analyzing a plurality of solid samples, comprising:
(a) a plurality of coring tools, each comprising a means for extruding a plug of solid;
(b) a means for exposing the plugs of solid to radiation; and
(c) a means for detecting scattered radiation.

### BRIEF DESCRIPTION OF THE FIGURES

FIG. 1—Illustrates a coring tool with a narrow region;

FIG. 2—Illustrates a coring tool with a bent rod;

FIG. 3—Illustrates an apparatus used to set cavity depth of coring tools;

FIG. 4—Illustrates loading a coring tool with solid material;

FIG. 5—Illustrates a coring tool after solid material is captured;

FIGS. 6A-6D—Illustrates various tapers for coring tips;

FIG. 7—Illustrates compression of a sample plug;

FIG. 8—Illustrates extrusion of a sample plug;

FIG. 9—Illustrates a coring tool rack;

FIG. 10—Illustrates a coring tool rack with lifting plate in raised position;

FIG. 11—Illustrates a coring tool rack with lifting plate in lowered position;

FIG. 12—Illustrates a pin bed for removal of coring rods;

FIG. 13—Illustrates important dimensions for sample analysis;

FIG. 14—Illustrates an unoptimized plate for sample analysis;

FIG. 15—Illustrates a plate with 2 holes per diagonal;

FIG. 16—Illustrates a plate with 3 holes per diagonal;

FIG. 17—Illustrates a plate with 4 holes per diagonal;

FIG. 18—Illustrates a plate with 8 holes per diagonal;

FIG. 19—Illustrates a plate for applications where the incident beam length is less than 10.00 mm;

FIG. 20—Illustrates a plate for applications with a maximum beam intensity.

### DETAILED DESCRIPTION OF THE INVENTION

The present invention encompasses methods and apparatuses for picking up, compressing, and precisely positioning small samples of material (e.g. amounts of less than about 5.00 mg), for the purpose of automating PXRD (Powder X-ray Diffraction), Raman Spectroscopy, or other compatible methods of analysis. Sample quantities can be, for example, less than about 5.00 mg, 2.5.00 mg, 1.00 mg, 750.00 micrograms, 500.00 micrograms, 250.00 micrograms, 100.00 micrograms, 50.00 micrograms, 25.00 micrograms, 10.00 micrograms, 5.00 micrograms, or 1.00 microgram of solid particles. Particular embodiments of the present invention involve coring a sample plug of powder from the bottom or sides of a vial using a coring tool that comprises a hollow needle with a slideable close fitting rod contained inside the hollow needle. See, Published Application No. US20040146434, filed Nov. 3, 2003, and International Publication No. WO04/042327, filed Nov. 3, 2003, the contents of which are incorporated by reference in their entireties. To provide optimal signal quality, a sample plug contained inside the needle tip can be compressed by the rod and extruded above the needle tip a small distance (e.g., about 0.10 mm to 1.00 mm) to allow optimal exposure to a beam of electromagnetic radiation. Each coring tool is, optionally, placed in a coring tool rack, which is defined as a substrate that precisely positions the sample plugs in x, y, and z coordinates relative to the rack base. The samples(s) is/are then placed on a cradle in a machine, such as a surface PXRD, that emits an electromagnetic beam of radiation which is directed through each sample plug to obtain information about the crystalline structure of each sample plug.

This method has several advantages over other methods known in the prior art. For example, a system described in the art involves forming crystals on a substrate that is used for PXRD and Raman spectroscopic analysis (See U.S. Pat. Nos. 6,371,640 and 6,605,473). The present invention has the following advantages over such a system for both PXRD and Raman Spectroscopy: 1) The coring tool of the present method serves to both mill and compress powder crystals prior to analysis, thus improving signal quality; 2) The coring tool of the present method also requires a smaller amount of sample for quantitative analysis; 3) The present method allows the heights of sample plugs to be adjusted so they are coplanar. This allows the angle of incidence of the X-ray beam to be closer to horizontal, thus improving signal quality without picking up signals from neighboring sample plugs; 4) The present invention leaves material behind that is not exposed to x-ray radiation and, hence, decreases the existence of radiation-damaged material; and 5) The present invention can be used to extract sample material prepared in sealable individual vials, which provide superior flexibility and protection of crystalline samples from the environment.

As used herein, the term “processing parameters” means the physical or chemical conditions under which a sample is subjected and the time during which the sample is subjected to such conditions. Processing parameters include, but are not limited to, adjusting the temperature; adjusting the time; adjusting the pH; adjusting the amount or the concentration of the sample; adjusting the amount or the concentration of a component; component identity (adding one or more additional components); adjusting the solvent removal rate; introducing a nucleation event; introducing a precipitation event; controlling evaporation of the solvent (e.g., adjusting a value of pressure or adjusting the evaporative surface area); and adjusting the solvent composition. Solid samples can be subjected to a diverse range of processing conditions before analysis is completed. The present invention provides the capacity to alter processing conditions from one sample to the next, or from one array of samples to the next, or from one sub-array of samples to the next. The isolation of each sample facilitates a more accurate analysis of solid material and is significantly less prone to contamination than other methods (e.g., plate-based methods).

Sub-arrays or even individual samples within an array can be subjected to processing parameters that are different from the processing parameters to which other sub-arrays or samples, within the same array, are subjected. Processing parameters can differ between sub-arrays or samples when they are intentionally varied to induce a measurable change in the sample's properties. Thus, according to the invention, minor variations, such as those introduced by slight adjustment errors, are not considered intentionally varied.

Embodiments of the invention are particularly suited for the automated or high-throughput analysis of solids such as, but not limited to, pharmaceuticals, excipients, dietary substances, alternative medicines, nutraceuticals, agrochemicals, sensory compounds, the active components of industrial formulations, and the active components of consumer formulations. Solids analyzed using the methods and devices of the invention can be amorphous, crystalline, or mixtures thereof.

In a first embodiment, the present invention provides a method for the analysis of a solid material, comprising:
(a) coring the solid material with a coring tool such that a plug is formed;
(b) extruding the plug of solid material;
(c) exposing the plug of solid material to radiation; and
(d) detecting scattered radiation.

In a specific embodiment of the present invention, the analysis comprises x-ray scattering. In another embodiment, the analysis comprises Raman scattering.

In another embodiment, the method further comprises compressing the solid material after the plug is formed.

In another embodiment, the method further comprises loading the coring tool onto a rack after the solid material is extruded.

A specific method of this embodiment comprises the steps of: (a) coring the solid material with a coring tool which comprises a narrow region in the needle of said coring tool or a bent rod inserted in the needle of said coring tool, such that a plug is formed; (b) compressing the plug of solid material with a mallet and a pin; (c) extruding the plug of compressed solid material with a pin; (d) loading the coring tool onto a rack; (e) exposing the compressed solid material to radiation; and (f) detecting scattered radiation.

In another embodiment, the position of a pin in step (b) is adjusted by a micrometer.

In another embodiment, the rack in step (d) comprises a top plate with one or more holes, and optionally, side walls and a bottom plate. Each hole in the top plate has a diameter which is about 10.00 micrometers, 20.00 micrometers, 30.00 micrometers, 40.00 micrometers, 50.00 micrometers, 60.00 micrometers, 70.00 micrometers, 80.00 micrometers, 90.00 micrometers, 100.00 micrometers, 150.00 micrometers, 200.00 micrometers, or 250.00 micrometers or more, greater than the diameter of the coring tool. In another embodiment, the rack comprises a top plate which is optionally made of polyvinyl chloride (PVC), chlorinated polyvinyl chloride (CPVC), or another material that absorbs X-ray radiation (or infrared or other radiation). In another embodiment, the rack comprises a plurality of holes.

In another embodiment, the rack in step (d) optionally comprises a lifting plate. The lifting plate optionally comprises one or more holes corresponding to the holes in the top plate. Optionally, the lifting plate can be locked into place via thumbscrews or another device. Stops may be used to define a maximum height, a minimum height, or an intermediate height of the lifting plate. The bottom plate of the rack optionally comprises one or more set screws for leveling, raising, or lowering the lifting plate.

In another embodiment, the rack in step (d) optionally further comprises a pin bed for removing one or more rods from the needle(s) of the coring tool(s). Optionally, the needles are held in place by a retainer plate. The retainer plate rests on walls (legs) which facilitate removal of coring tool rods. Alignment and stabilization of the retainer plate can optionally be performed by screws, pins, or other means.

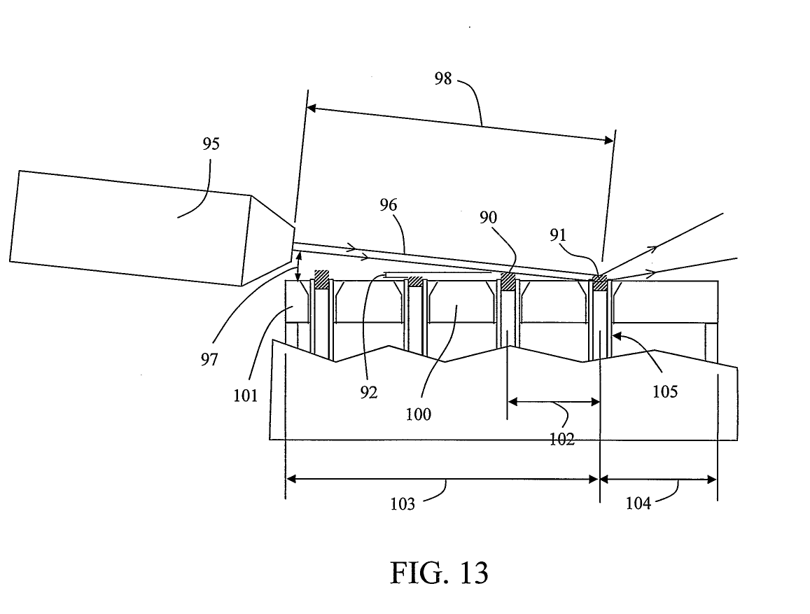

In another embodiment, an x-ray probe emits radiation in a beam with a beam length less than or equal to about 50.00 mm, 40.00 mm, 30.00 mm, 20.00 mm, 10.00 mm, or 5.00 mm. The beam length is defined as the distance between the x-ray probe emission aperture and the solid material loaded onto the coring tool (See item 98 of FIG. 13). Optionally, the beam is collimated. The angle of incidence between the emitted beam and the top plate of the rack is, for example, but not limited to, less than or equal to about 2.50 degrees, 2.25 degrees, 2.00 degrees, 1.75 degrees, 1.50 degrees, 1.25 degrees, or 1.00 degrees. For example, about 2.50, 2.40, 2.30, 2.20, 2.10, 2.00, 1.90, 1.80, 1.70, 1.60, 1.50, 1.40, 1.30, 1.20, 1.10, 1.00, 0.90, 0.80, 0.70, 0.60, or 0.50 degrees.

In another embodiment, the present invention provides a method for the analysis of a plurality of solid samples, comprising:
(a) coring each solid sample with a coring tool such that each solid sample forms a plug;
(b) extruding each plug of solid material;
(c) exposing each plug of solid material to radiation; and
(d) detecting scattered radiation.

In another embodiment, the present invention provides a system for analyzing a solid material, comprising:
(a) a coring tool comprising a means for extruding a plug of solid material;
(b) a means for exposing the plug of solid material to radiation; and
(c) a means for detecting scattered radiation.

In another embodiment, the present invention provides a system for analyzing a plurality of solid samples, comprising:
(a) a plurality of coring tools, each comprising a means for extruding a plug of solid;
(b) a means for exposing the plugs of solid to radiation; and
(c) a means for detecting scattered radiation.

Certain embodiments of the invention, as well as certain novel and unexpected advantages of the invention, are illustrated by the following non-limiting examples.

### Exemplification

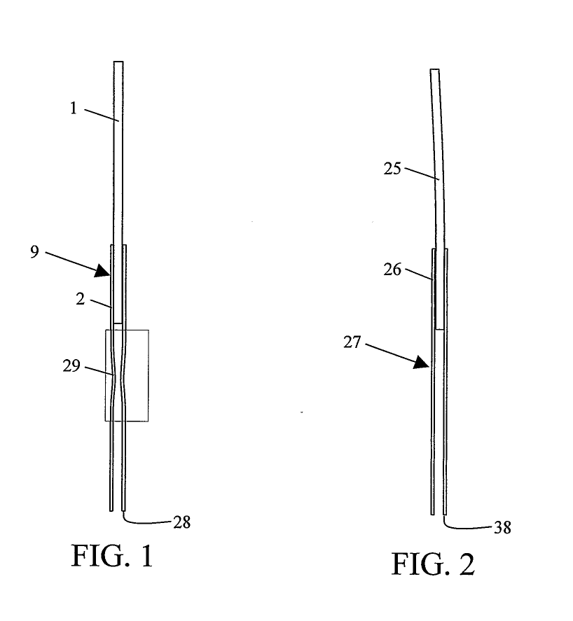

FIG. 1 shows coring tool 9 comprising rod 1 partially inserted into hollow needle 2 with square end 28. Narrow region 29 on needle 2 provides a light friction fit with rod 1, thus allowing the position of rod 1 to remain stationary relative to needle 2 until adjusted with the application of a small force (e.g., from about 0.10 Newtons to about 4.00 Newtons).

FIG. 2 shows coring tool 27 comprising bent rod 25 partially inserted into hollow needle 26 with square end 38. Rod 25 is slightly bent to provide a light friction fit with needle 26, thus allowing the position of rod 25 to remain stationary relative to needle 26 until adjusted with the application of a small force (e.g., from about 0.10 Newtons to about 4.00 Newtons). A suitable material for needles and rods is, for example, but not limited to, steel (e.g., stainless steel, 300 series stainless steel). For the present invention a useful inner needle diameter range is from about 50.00 micrometers to about 2000.00 micrometers, for example, about 50.00, 60.00, 70.00, 80.00, 90.00, 100.00, 125.00, 150.00, 175.00, 200.00, 250.00, 300.00, 400.00, 500.00, 600.00, 700.00, 800.00, 900.00, 1000.00, 1100.00, 1200.00, 1300.00, 1400.00, 1500.00, 1600.00, 1700.00, 1800.00, 1900.00, or 2000.00 micrometers or any intermediate value, and a useful needle wall thickness range is from about 10.00 micrometers to about 300.00 micrometers, for example, about 10.00, 15.00, 20.00, 25.00, 30.00, 40.00, 50.00, 60.00, 70.00, 80.00, 90.00, 100.00, 125.00, 150.00, 175.00, 200.00, 225.00, 250.00, 275.00, or 300.00 micrometers. A useful needle length is from about 1.00 mm to about 100.00 mm, for example, about 1.00, 1.50, 2.00, 2.50, 3.00, 4.00, 5.00, 6.00, 7.00, 8.00, 9.00, 10.00, 15.00, 20.00, 25.00, 30.00, 40.00, 50.00, 60.00, 70.00, 80.00, 90.00, or 100.00 mm. All ranges of distance and force mentioned herein (e.g., 50.00, 60.00, 70.00, 80.00, 90.00, 100.00, 125.00, 150.00, 175.00, 200.00, 250.00, 300.00, 400.00, 500.00, 600.00, 700.00, 800.00, 900.00, 1000.00, 1100.00, 1200.00, 1300.00, 1400.00, 1500.00, 1600.00, 1700.00, 1800.00, 1900.00, or 2000.00 micrometers) are to be taken as including, and providing written description and support for, any fractional value, in intervals of, for example, 0.01 micrometers, 0.01 mm, or 0.01 Newtons.

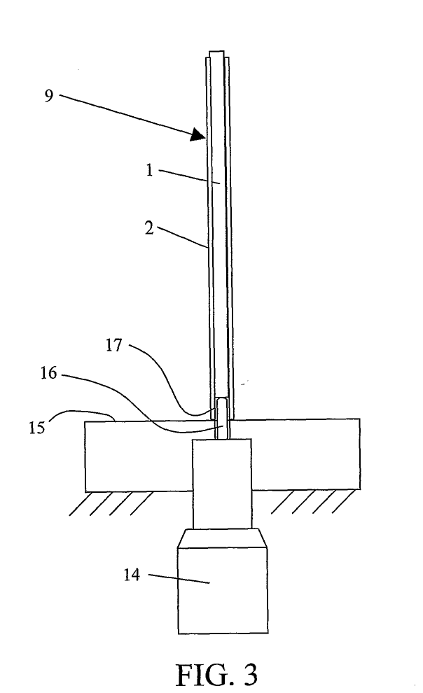

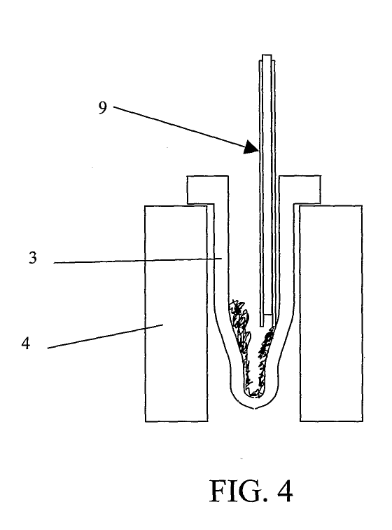

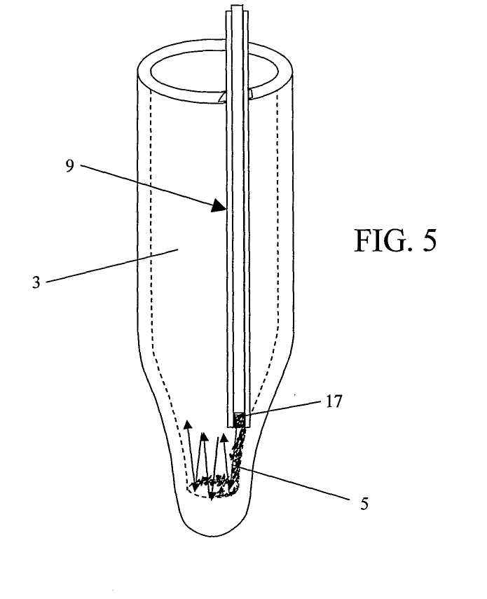

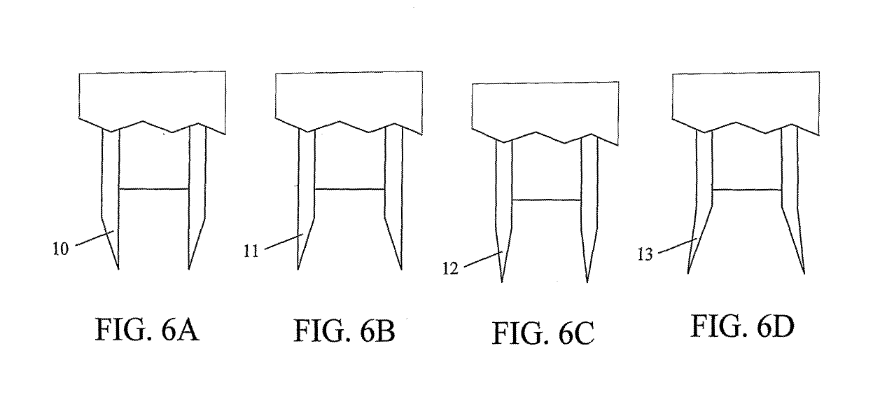

The first step of the present coring method involves setting the height of a coring cavity in needle 2. FIG. 3 shows the depth of needle tip cavity 17 of coring tool 9 being set by pin 16. The height of pin 16 above surface 15 can be adjusted by micrometer 14. Next, as shown in FIG. 4, coring tool 9 can be inserted into vial 3 which is supported by vial block 4, or another means. As shown in FIG. 5, cavity 17 can be filled by moving coring tool 9 up and down inside vial 3, or another means, so that powder S is scraped off the walls or removed from the bottom of vial 3. To facilitate the scraping and milling process, needles with tip geometries shown in FIGS. 6a through 6d can be used instead of needle 2 with square end 28 (FIG. 1). FIG. 6a shows sharp end 10 with an exterior taper, FIG. 6b shows sharp end 11 with an interior taper, FIG. 6c shows sharp end 12 with both interior and exterior tapers, and FIG. 6d shows flared sharp end 13 with an interior taper.

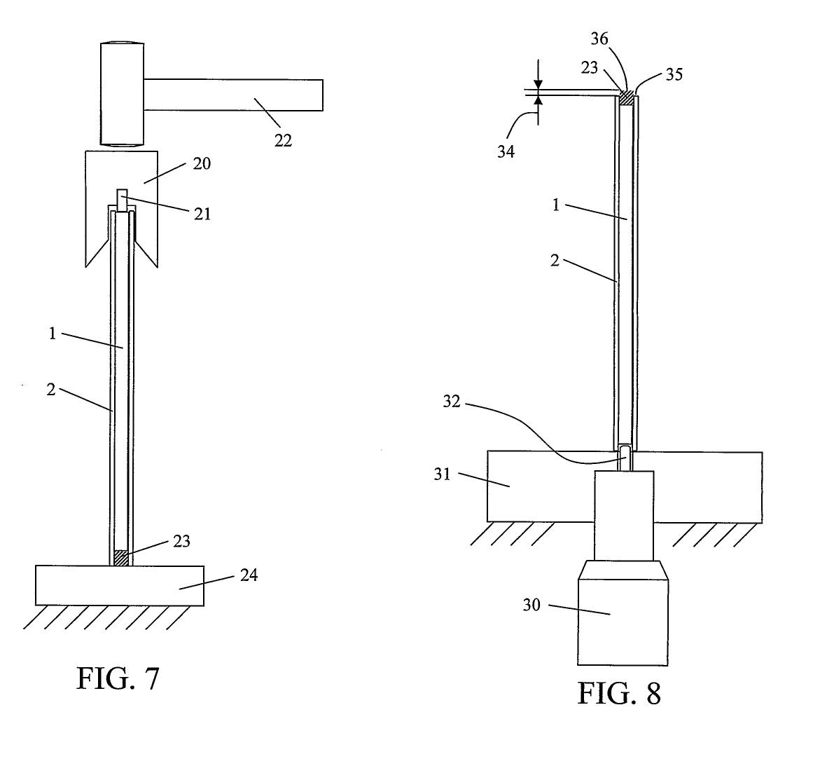

Next, sample plug 23 can be compressed and extruded, as illustrated in FIG. 7 and FIG. 8, respectively. In FIG. 7, mallet 22 strikes thimble 20 which includes pin 21, thus pushing rod 1 and thus compressing sample plug 23 into block 24. In FIG. 8, needle 2 is inverted and placed on base 31, causing pin 32 to push rod 1 a distance sufficient to extrude plug top 36 a distance 34 ranging from, for example, about 0.10 mm to about 1.00 mm above needle tip 35. Distance 34 can be adjusted by micrometer 30, or another means.

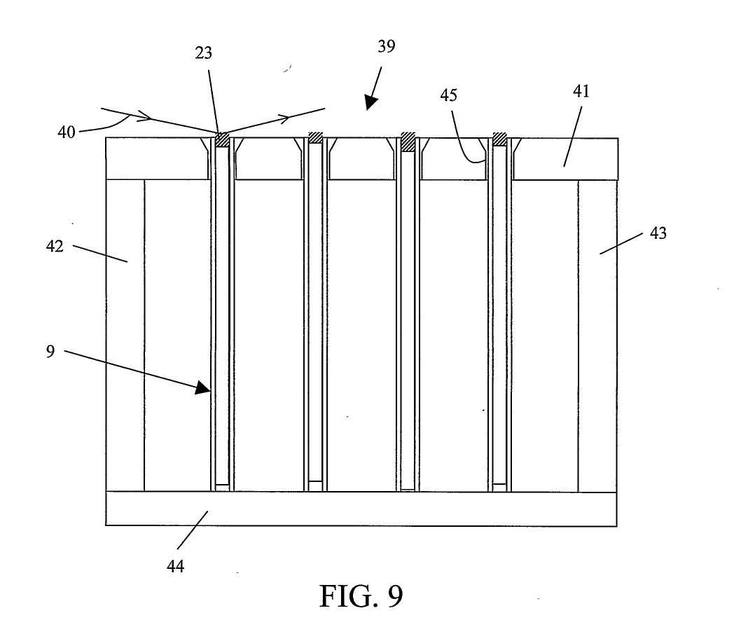

Next, coring tools can be loaded into coring tool rack 39 shown in FIG. 9. Coring tool rack 39 comprises top plate 41 with a plethora of holes 45, side walls 42 and 43, and a bottom plate 44. Next, each sample plug can be sequentially exposed to electromagnetic radiation. Holes 45 have diameters that are about10.00 micrometers to about 100.00 micrometers larger than coring tools 9 to allow coring tools 9 to be accurately constrained laterally but to slide freely vertically. FIG. 9 illustrates X-ray beam 40 passing through sample plug 23 and being diffracted, allowing sample plug 23 to be analyzed. For X-ray applications, top plate 41 material is optionally PVC or CPVC to fully absorb X-rays (or infrared or other radiation) that strike top plate 41 and thus eliminate the occurrence of reflected x-rays.

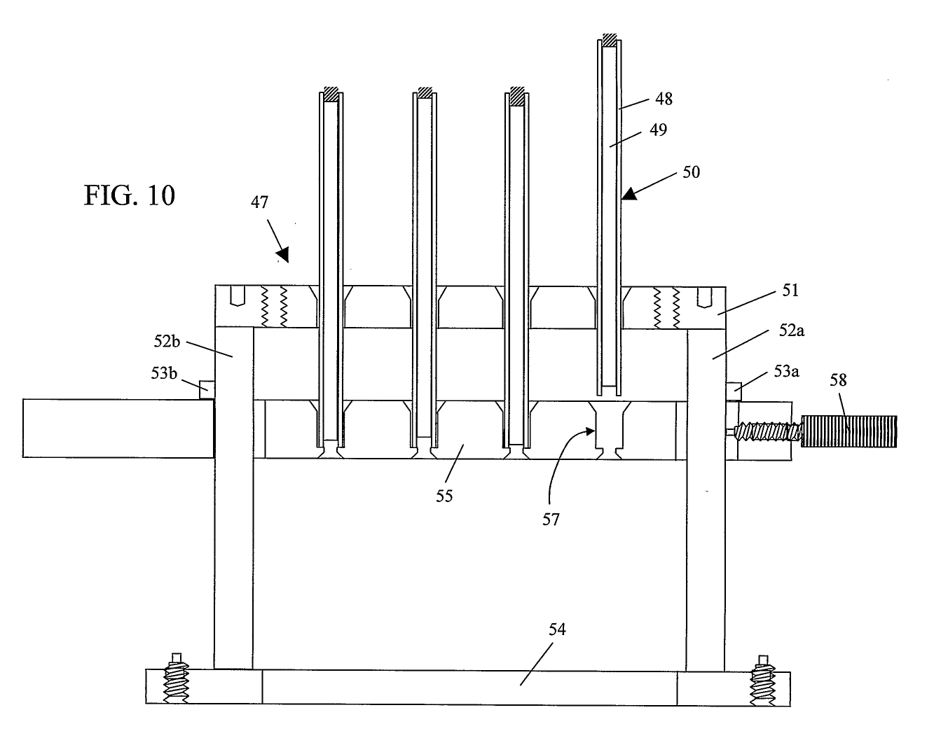

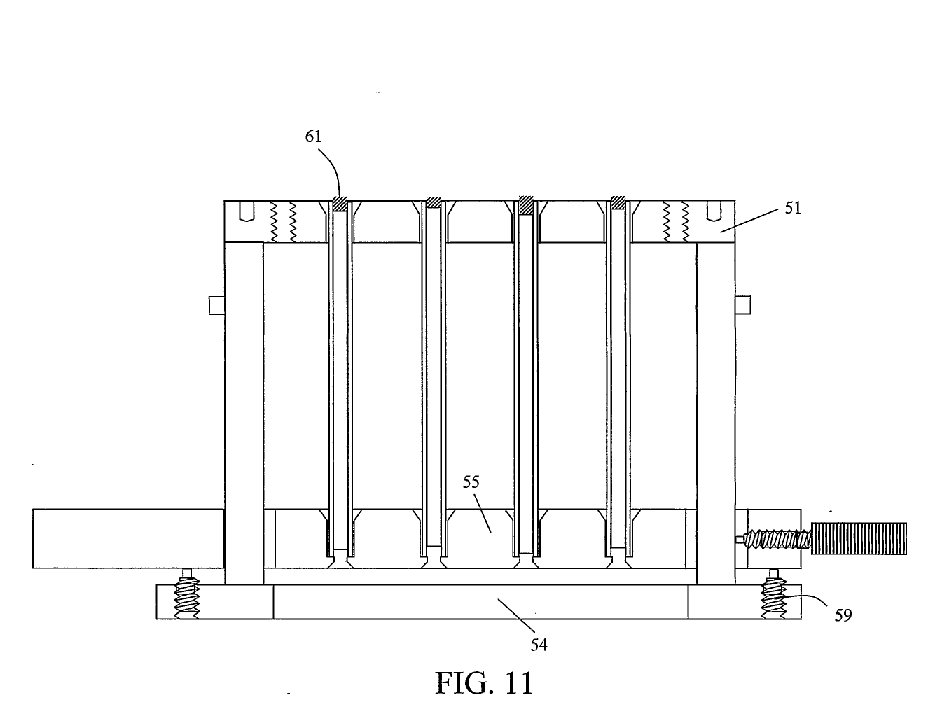

FIGS. 10 and 11 show a coring tool rack which allows needle tips to be held above the top plate during the needle loading step, thus allowing for easier manual insertion of the needles. Coring tool rack 47 comprises top plate 51, side walls 52a and 52b, base 54, and lifting plate 55. Coring tools 50 can be inserted through top plate 51 and into holes 57 in lifting plate 55 while lifting plate 55 is locked via thumbscrew 58 in a raised position. Stops 53a and 53b define the maximum height of lifting plate 55. After rack 47 is fully loaded, thumb screw 58 is loosened and lifting plate 55 is lowered so that plug top surfaces 61 are nominally above top plate 51 a distance between 0.00 mm and 2.00 mm, as shown in FIG. 11. Lifting plate 55 can be leveled, raised or lowered via set screws in base 54 such as screw 59.

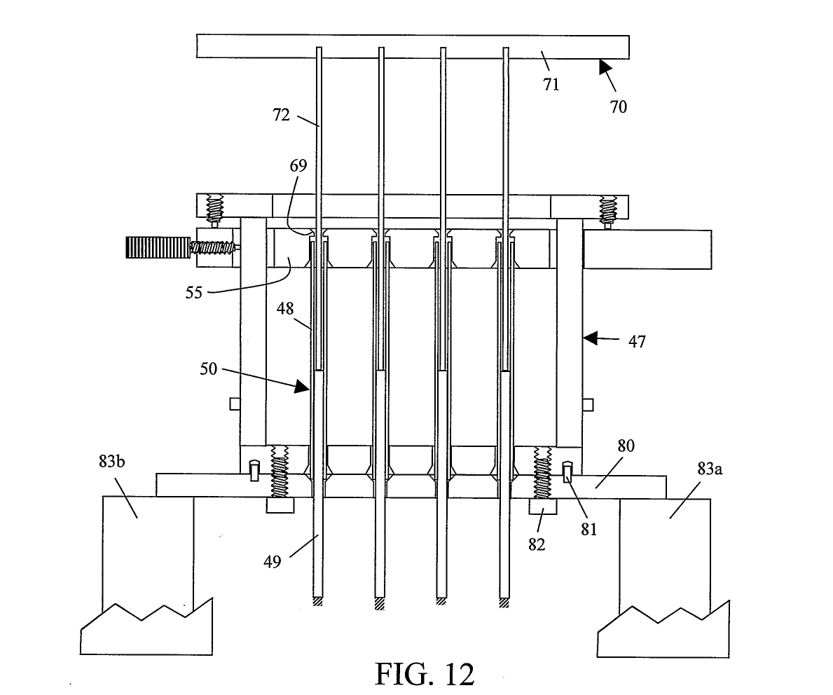

FIG. 12 shows pin bed 70 which allows coring tool pins 49 in rack 47 to be removed from needles 48 in one motion, thus reducing labor required to remove pins 49. Pin bed 70, comprising base 71 and pins 72, is inserted through chamfered holes 69 in lifting plate 55, pushing pins 49 out of needles 48. Needles 48 are held in place by retainer plate 80 secured by screws 82 and aligned by pins 81. Retainer plate 80 rests on walls 83a and 83b that are sufficiently high to allow pins 49 to be completely removed.

FIG. 13 illustrates important dimensions associated with X-ray diffraction analysis using a coring tool rack of the present invention. X-ray probe 95 emits beam 96 which intersects with sample plug 91 and is diffracted. In order to obtain a high signal to noise ratio it is important to minimize the incident beam length 98 of X-ray beam 96. As an example, for a model D8 Discover Powder X-Ray Diffraction machine manufactured by Bruker AXS Limited, (Congleton, Cheshire, UK), using a snout style collimator equipped with 0.50 mm pin holes, a suitable incident beam length 98 is 50.00 mm or less to achieve acceptable beam intensity. To ensure that undiffracted x-rays (or infrared or other radiation) are absorbed, top plate 100 should extend a distance 104 of 15.00 mm or greater beyond the farthest plugs 91. Also, it is important for angle of incidence 97 to be 2.50 degrees or less to allow complete information to be obtained from the sample plugs being analyzed. To ensure probe 9 does not collide with leading edge 101 or sample plugs, given incident beam length 98 is equal to 50.00 mm, total array width 103 must be less than 50.00 mm. Within this maximum array width constraint, it is desirable to design a coring tool rack that maximizes sample plug spacing 102 between adjacent sample plugs in the direction of beam 96 to allow beam 96 to pass over adjacent plugs such as 90 when there is a height difference between neighboring plugs (shown for example as height difference 92) due to an inaccurate adjustment of plug heights. Given beam 96 has a nominal diameter of 0.50 mm, and angle of incidence 97 is two degrees, it is desirable for sample plug spacing 102 to be greater than 18.00 mm in order to tolerate a plug height difference of 0.50 mm. To accommodate an even larger height difference, a sample plug spacing of larger than 18.00 mm is desirable. The following coring tool rack embodiments address these conflicting design requirements while also maximizing the number of sample plugs present per rack, providing ease of needle loading, and providing intuitive placement and labeling of rows and columns.

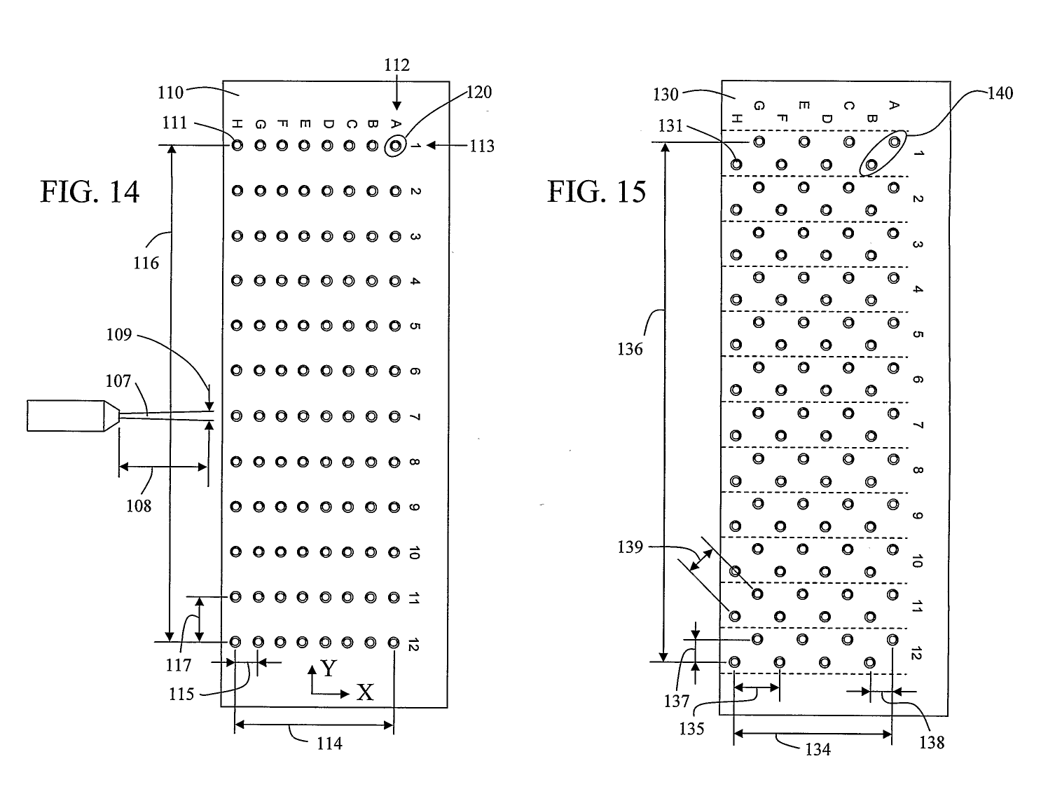

FIG. 14 shows a top view of an unoptimized top plate 110 with holes 111 arrayed in a traditional grid format, with hole rows 112 and hole columns 113. X-ray beam 107 and hole columns 113 are nominally parallel and are in the x-direction relative to top plate 110. At an incident beam length 108 of 50.00 mm, beam width 109 is commonly 0.50 mm to 1.00 mm, but can range from about 0.10 mm to about 5.00 mm, depending on the beam diameter that is needed for a particular application. To prevent beam 107 from intersecting neighboring sample plugs in the y-direction in the event of positioning errors, y-hole spacing 117 should be equal to beam width 109 plus a tolerance of 0.40 mm or greater.

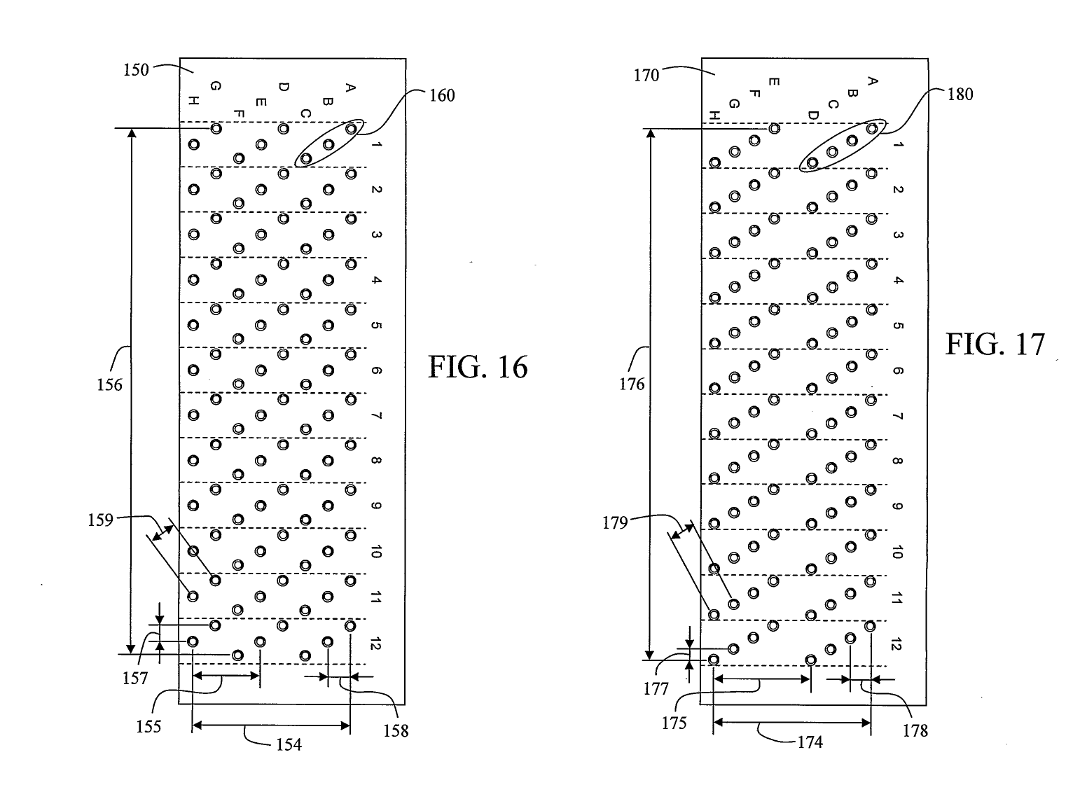

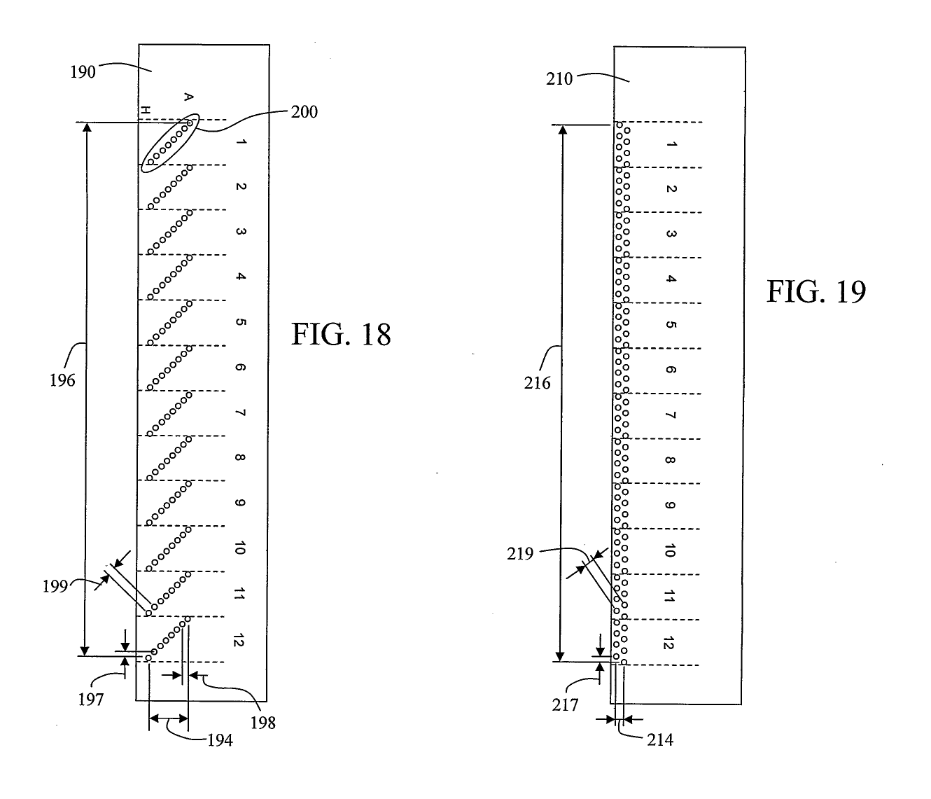

FIG. 15, FIG. 16, FIG. 17 and FIG. 18 show top plates 130, 150, 170, and 190 respectively, with hole patterns that maximize hole spacing in the x-direction, given a minimum allowed hole spacing in the y-direction, and a minimum allowed distance between holes. To aid discussion and allow formulas to be presented, Table 1 assigns variable names to the dimension labels shown in FIGS. 14 through 18.

TABLE 1
Variable names assigned to dimension labels in FIGS. 14 through 18

| | | Dimension Labels | | | | |
|---|---|---|---|---|---|---|
| Variable Name | Symbol | FIG. 14 | FIG. 15 | FIG. 16 | FIG. 17 | FIG. 18 |
| Holes per Diagonal | n_{d} | item 120 | item 140 | item 160 | item 180 | item 200 |
| Array Length | Lₐ | dim. 114 | dim. 134 | dim. 154 | dim. 174 | Dim. 194 |
| Array Width | Wₐ | dim. 116 | dim. 136 | dim. 156 | dim. 176 | Dim. 196 |
| X Hole Spacing 1 | s₁ₓ | dim. 115 | dim. 138 | dim. 158 | dim. 178 | Dim. 198 |
| X Hole Spacing 2 | s₂ₓ | dim. 115 | dim. 135 | dim. 155 | dim. 175 | NA |
| Y Hole Spacing | s_{y} | dim. 117 | dim. 137 | dim. 157 | dim. 177 | Dim. 197 |
| Min. Hole Distance | s | dim. 115 | dim. 139 | dim. 159 | dim. 179 | Dim. 199 |

Given the number of holes per diagonal in a column, represented by n_{d}, the number of holes per row n_{y}, the array width Wₐ, and X hole spacing 1 s₁ₓ, the Y hole spacing s_{y} and minimum hole distance s can be computed via equation (1) and equation (2), respectively.

$$\begin{matrix}{s}_{y} = \frac{{W}_{a}}{{n}_{d} {n}_{y} - 1} & ( 1 ) \\ s = \sqrt{{s}_{1 x}^{2} + {s}_{y}^{2}} & ( 2 )\end{matrix}$$

Given 8 holes per column (nₓ=8), the resulting X hole spacing 2 S₂ₓ can be computed given the number of holes per diagonal nd, the array length La, and X hole spacing 1 s₁ₓ, according to Table 2.

TABLE 2
s₂ₓ versus n_{d} given nₓ = 8

| n_{d} = | S₂ₓ = |
|---|---|
| 1 | Lₐ/7 |
| 2 | (Lₐ − s₁ₓ)/3 |
| 3 | (Lₐ − s₁ₓ)/2 |
| 4 | Lₐ − 3s₁ₓ |
| 5 | Lₐ − 2s₁ₓ |
| 6 | Lₐ − s₁ₓ |
| 7 | Lₐ |
| 8 | infinity |

Table 3 shows computed values for s, s_{y} and S₂ₓ, given some example values for the input variables in Equation (1), Equation (2), and the equations in Table 2.

TABLE 3
Computed values for s, s_{y} and s₂ₓ

| | | Variable Values | | | | | | | | | |
|---|---|---|---|---|---|---|---|---|---|---|---|
| Variable Name | Symbol | FIG. 14 | | FIG. 15 | | FIG. 16 | | FIG. 17 | | FIG. 18 | |
| Holes per Diagonal | n_{d} | 1 | | 2 | | 3 | | 4 | | 8 | |
| Holes per Column | nₓ | 8 | | 8 | | 8 | | 8 | | 8 | |
| Holes per Row | n_{y} | 12 | | 12 | | 12 | | 12 | | 12 | |
| Array Length | Lₐ | 46.90 | mm | 46.90 | mm | 46.90 | mm | 46.90 | mm | 14.00 | mm |
| Array Width | Wₐ | 99.00 | mm | 99.00 | mm | 99.00 | mm | 99.00 | mm | 99.00 | mm |
| X Hole Spacing 1 | s₁ₓ | 9.00 | mm | 6.70 | mm | 6.70 | mm | 5.00 | mm | 2.00 | mm |
| Min. Hole Distance | s | 9.00 | mm | 8.00 | mm | 7.30 | mm | 5.40 | mm | 2.30 | mm |
| Y Hole Spacing | s_{y} | 9.00 | mm | 4.30 | mm | 2.80 | mm | 2.10 | mm | 1.00 | mm |

| | | | | | | | | | | |
|---|---|---|---|---|---|---|---|---|---|---|
| X Hole Spacing 2 | s₂ₓ | 6.70 | mm | 13.40 | mm | 20.10 | mm | 31.90 | mm | NA |

As an example which includes realistic constraints, given a beam width of 1.00 mm and a width tolerance of 0.40 mm, s_{y} should be 1.40 mm or larger. As stated earlier, given a beam incident angle of 2 degrees, s₂ₓ should be greater than 18.00 mm to tolerate a 0.50 mm plug height difference. Lastly, it is desirable for array length Lₐ to be 50.00 mm or less to minimize beam travel. As can be seen in Table 3, the n_{d}=4 embodiment in FIG. 17 more than satisfies these constraints. Given Lₐ=46.90 mm, the n_{d}=4 design can provide s_{y}=2.10 mm while providing S₂ₓ=31.90 mm. At the same time, the conventional grid embodiment in FIG. 14 indicated by n_{d}=1 yields only s₂ₓ=6.70 mm, which is far from satisfying the constraints in this example.

If the beam width used was 0.60 mm instead of 1.00 mm, then an s_{y} value of 1.00 mm could be tolerated, and the n_{d}=8 embodiment in FIG. 18 could be used. The n_{d}=8 embodiment has two advantages: 1) it eliminates neighbors altogether in the x-direction; and 2) the array length La is reduced to 14 mm in the Table 3 example, thus allowing a significantly shorter incident beam length and hence a potentially higher beam intensity. A disadvantage of the n_{d}=8 embodiment is that needles are more difficult to insert into holes without disrupting neighbors because the minimum hole distance 199 is significantly reduced.

For applications where the incident beam length used is less than 10.00 mm, the hole pattern shown on top plate 210 in FIG. 19 is suitable. An advantage over the previous embodiments is that array length 214 is significantly reduced, and thus the incident beam length used and hence signal strength could be increased. In such an embodiment, the y hole spacing 217 and minimum hole distance 219 are more constrained given a maximum array width 216.

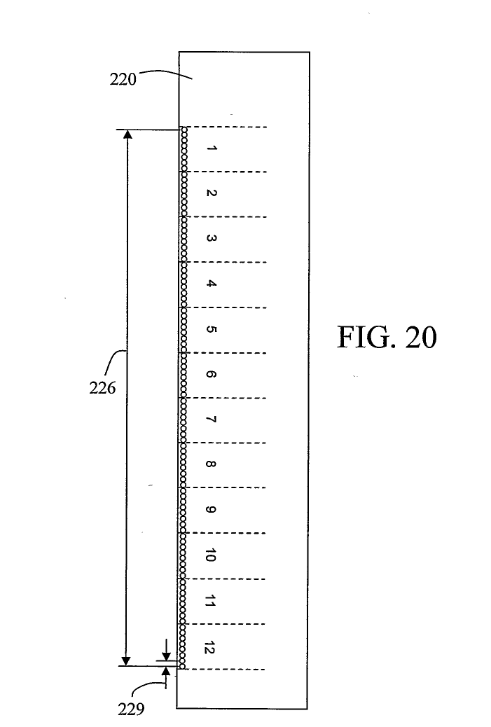

FIG. 20 shows top plate 220 which enables maximum beam intensity. As a consequence, the FIG. 20 embodiment results in the smallest minimum hole distance 229 given an array width 226, compared to the previous embodiments.

Having now fully described this invention, it will be understood by those of ordinary skill in the art that the same can be performed within a wide and equivalent range of conditions and other parameters without affecting the scope of the invention or any embodiment thereof For example, functional aspects of the present invention such as, but not limited to, thumbscrews, pins, and screws may also be satisfied using alternative means and, therefore, are included in the present invention. All patents and publications cited herein are fully incorporated by reference in their entireties.

1-26. (canceled)

27. A method for analysis of a solid material, comprising:
(a) coring the solid material with a coring tool such that a plug is formed;
(b) extruding the plug of solid material
(c) exposing the plug of solid material to radiation; and
(d) detecting scattered radiation.

28. The method for analysis of a solid material of claim 27, further comprising compressing said solid material after said plug is formed.

29. The method for analysis of a solid material of claim 7, further comprising loading said coring tool onto a rack after said solid material is extruded.

30. The method for analysis of a solid material of claim 29, wherein said rack comprises a top plate with one or more holes.

31. The method for analysis of a solid material of claim 30, wherein said top plate is composed of a material that absorbs x-ray radiation.

32. The method for analysis of a solid material of claim 27, wherein a pin is used to extrude said plug of solid material.

33. The method for analysis of a solid material of claim 32, wherein a micrometer is used to adjust the position of said pin.

34. The method for analysis of a solid material of claim 29, wherein said rack further comprises a lifting plate.

35. The method for analysis of a solid material of claim 27, wherein said radiation is x-ray radiation.

36. The method for analysis of a solid material of claim 27, wherein said radiation is infrared radiation.

37. The method for analysis of a solid material of claim 35, wherein said x-ray radiation is emitted with an angle of incidence less than or equal to 2.50 degrees.

38. A method for the analysis of a plurality of solid samples, comprising:
(a) coring each solid sample with a coring tool such that each solid sample forms a plug;
(b) extruding each plug of solid material;
(c) exposing each plug of solid material to radiation; and
(d) detecting scattered radiation.

39. A system for analyzing a solid material, comprising:
(a) a coring tool comprising a means for extruding a plug of solid material;
(b) a means for exposing the plug of solid material to radiation; and
(c) a means for detecting scattered radiation.

40. The system for analyzing a solid material of claim 39, further comprising a means for compressing said solid material.

41. The system for analyzing a solid material of claim 39, further comprising a rack, wherein said rack comprises a top plate with one or more holes.

42. The system for analyzing a solid material of claim 41, wherein said top plate is composed of a material that absorbs x-ray radiation.

43. The system for analyzing a solid material of claim 39, wherein a plurality of solid materials is analyzed.
